(19) United States
(12) Patent Application Publication
(10) Pub. No.: US 2026/0350406 A1
(43) Pub. Date: Nov. 5, 2026

(54) IMITATION LEARNING USING SHAPED REWARDS

(71) Applicant: GDM Holding LLC, Mountain View, CA (US)

(72) Inventors: Joseph Matthew Watson, Darmstadt (DE); Sandy Han Huang, London (GB); Nicolas Manfred Otto Heess, London (GB)

(21) Appl. No.: 19/484,685

(22) PCT Filed: May 15, 2024
(86) PCT No.: PCT/EP2024/063450

§ 371 Date: Nov. 14, 2025

Related U.S. Application Data
(60) Provisional application No. 63/502,744, filed on May 17, 2023.

(51) Int. Cl. G06N 3/092; G06N 3/048; G06N 3/084; G06N 3/096

(52) U.S. Cl. CPC G06N 3/092; G06N 3/048; G06N 3/084; G06N 3/096

(57) ABSTRACT

Systems and methods, implemented as computer programs on one or more computers in one or more locations, for learning to control an agent to perform a task. The method involves training a policy neural network on demonstration actions that perform the task to obtain an initial, cloned action selection policy, determining a shaped reward using the cloned policy, then using the shaped reward to fine tune the policy neural network. The system can transition smoothly between learning to copy actions of a task demonstrated by an agent such as a human expert, and refining the learned actions. The system can also learn to recover gracefully when outside a distribution of actions of the demonstrating agent.

### BACKGROUND

This specification relates to imitation learning.

An imitation learning system learns to perform a task from demonstrations of the task by an expert such as a human or another machine learning system. An agent can interact with an environment by performing actions that are selected by the imitation learning system after it has been trained, in response to receiving observations that characterize the current state of the environment, to perform the task. The actions are selected in accordance with an output of a trained neural network.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes systems and methods, implemented as computer programs on one or more computers in one or more locations, for learning to control an agent to perform a task. The system can transition smoothly between learning to copy actions of a task demonstrated by an agent such as a human expert, and refining the learned actions using a shaped reward that may be described as “coherent”. Implementations of the system can also learn to recover gracefully when outside a distribution of actions of the demonstrating agent.

In one aspect there is described a computer-implemented method of training a policy neural network to select actions to be performed by an agent in an environment to perform a task. The policy neural network is configured to process an observation characterizing a state of the environment to generate an action selection output for controlling the agent.

The method generally involves training the policy neural network on demonstration actions that perform the task to obtain an initial, cloned action selection policy; determining a shaped reward that is coherent or consistent with the cloned policy; and then using the shaped reward, e.g. using a refinement of the shaped reward, to fine tune the policy neural network.

This specification also describes a system comprising one or more computers, and one or more storage devices communicatively coupled to the one or more computers, the storage devices storing instructions that, when executed by the one or more computers, cause the one or more computers to perform the operations of the described methods.

This specification further describes software to implement the described methods, e.g. one or more non-transitory computer storage media storing instructions that when executed by one or more computers perform the operations of a described method.

The subject matter described in this specification can be implemented in particular embodiments so as to realize one or more of the following advantages.

The described techniques are able to learn to perform tasks more effectively than some other approaches. For example implementations of the system can solve some control tasks using a single demonstration, and can solve complex control tasks where an approach based purely on behavioral cloning struggles. The described techniques are data-efficient, and can be less complex than some inverse reinforcement learning approaches that jointly learn a policy and reward from interactions with an environment.

In general previous approaches have often either learned through direct mimicry, e.g. behavioral cloning, or by inferring a latent reward using inverse reinforcement learning. However these approaches have been largely separated as the process of policy optimization with an evolving reward estimate tends to counteract the benefit of cloning the initial behavioral policy. The described approach allows these two alternatives to be combined, providing sample-efficient policy optimization and allowing any type of behavioral cloning policy to be improved using additional experience.

An estimate of a shaped reward can be used to fine tune the cloned policy using additional knowledge, such as online interactions, offline data or a dynamics model. In implementations using the behavioral cloning policy to define the shaped reward can avoid a need for the careful regularization and hyperparameter tuning typically associated with adversarial imitation learning, hence facilitating deployment.

In implementations of the system the shaped reward is “coherent” with the cloned policy and the initial cloned policy can be (approximately) optimal for the shaped reward. The initial cloned policy can be used as a reference policy when updating a critic used for improving the action selection policy.

The shaped reward can be based on a prior action selection policy, e.g. a uniform action selection policy. Some implementations of the techniques use KL-regularized learning (a log policy ratio) to derive an estimate of the shaped reward from the cloned policy; this can facilitate learning recovery behavior when outside of the demonstration distribution. This can help the system to learn to recover when outside the demonstration distribution, because the shaped reward incentivizes the system how to return to this distribution, and thus the system can learn to recover better when confronted with observations that are significantly different to those in the demonstration data. Some implementations of the system further facilitate such recovery by modifying the architecture of the policy neural network to include a periodic activation function. This can help to define the out-of-distribution behavior.

In general implementations of the system also benefit from a strong theoretical foundation, and associated theoretical guarantees.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a system for training a policy neural network.

FIG. 2 is a flow diagram of an example process for training a policy neural network.

FIG. 3 illustrates reward shaping.

FIG. 4 compares the performance of imitation learning techniques using offline learning.

FIG. 5 compares the performance of imitation learning techniques using online learning.

Like reference numbers and designations in the various drawings indicate like elements.

### DETAILED DESCRIPTION

This specification generally describes systems for imitation learning. Implementations of the system capture benefits of both behavioral cloning and inverse reinforcement learning by using a behavioral cloning technique to determine a shaped reward. This can then be used to fine tune an action selection policy, in some implementations using additional interactions with an environment.

The shaped reward is consistent or “coherent” with an action selection policy learned by behavioral cloning. That is, after behavioral cloning on demonstration data the shaped reward should indicate actions that are close to expert actions in in the demonstration data, and thus further fine tuning using the reward can avoid “unlearning”.

In implementations of the system, when outside the demonstration data distribution learned state-values can encourage actions that return to the demonstration distribution, as the coherent, shaped reward is higher in this region.

Additional interactions that are used to fine tune an action selection policy can be obtained by online interaction with the or a similar environment, or from an offline dataset, or from a dynamics model. The technique allows additional, external rewards from the environment to be incorporated during the fine tuning, if available.

In broad terms implementations of the described techniques learn an initial action selection policy using behavioral cloning, use the initial action selection policy to define the shaped reward (the initial, behavioral cloning action selection policy is optimal for this reward), and then fine tune the action selection policy using reinforcement learning based on the shaped reward, or on a refinement of this reward. The techniques do not rely on the use of a particular type of reinforcement learning; for example model-based or model-free reinforcement learning can be used. In general the expert demonstrations may not cover the entire state-action space and there can be regions where the initial action selection policy is undefined and potentially ineffective. Reinforcement learning, e.g. using additional environment interactions and the shaped reward, can improve the policy in these gaps.

The reward function can be shaped without changing the optimal policy. In implementations the shaped reward is defined based on, i.e. dependent upon, a log policy ratio between the initial action selection policy and a prior action selection policy. Broadly this amounts to regularizing the initial action selection policy based on a metric of a distance, e.g. a KL (Kullback-Leibler) distance, to the prior.

More particularly, deviations of the initial action selection policy from the prior are penalized, in particular with a weight, α, that defines an initial “temperature” of the process. When fine tuning the action selection policy using reinforcement learning, deviations of the fine-tuned policy from a (training) reference action selection policy can be penalized with a weight, β, that defines a second, refinement temperature of the process. The (training) reference action selection policy can be, e.g., the initial action selection policy or an earlier version of the fine-tuned policy, or potentially even the prior. The weight β can be less than the weight α to facilitate deviation from the reference policy during the reinforcement learning, and hence policy improvement.

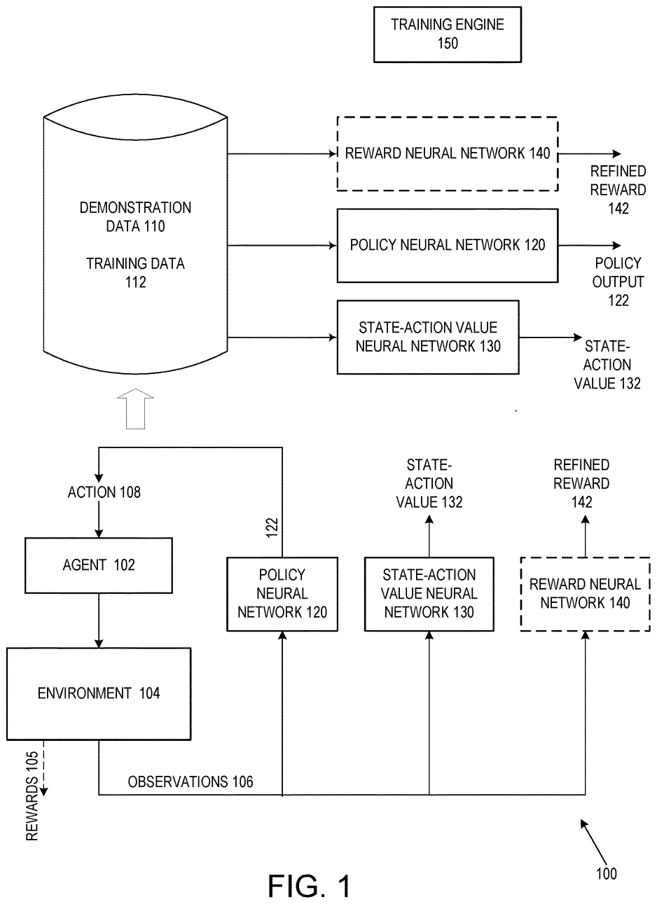

FIG. 1 shows an example of a system 100 that may be implemented as one or more computer programs on one or more computers in one or more locations, for training a policy neural network 120. The policy neural network 120 is used, during or after training, to control an agent 102 interacting with an environment 104 to select actions 108 to be performed by the agent to perform a task.

The example implementation of system 100 also includes a state-action value neural network 130, in particular a Q-value neural network. This may also be referred to as a “critic”. Some implementations of the system 100 include a reward neural network 140, as described later.

In FIG. 1 the policy neural network 120, the state-action value neural network 130, and the reward neural network 140 are each depicted twice for convenience of illustration, but the two depictions are of the same neural network in each case.

The system 100 has access to demonstration data 110, e.g. stored in a local or remote data store. The demonstration data comprises a sequence of demonstration observations and demonstration actions of a demonstrating agent performing the task. The demonstration observations characterize states of a demonstration environment in which the demonstrating agent performs the task and the demonstration actions comprise actions the demonstrating agent takes to perform the task. The demonstration environment may be the same as or different to the environment in which the agent is trained to act. For example the demonstration environment may be a simulation of a real environment and the agent may later act in the real environment. The demonstrating agent or “expert” may be a human, or another machine learning system, or both.

The system 100 also has access to training data 112, e.g. stored in a local or remote data store. The training data may be obtained from an offline dataset, e.g. it may comprise further demonstration data; or from online interactions with an environment, e.g. an environment in which the agent will be used; or from a simulation or dynamics model, e.g. of an environment in which the agent will be used; or from a combination of these.

The training data comprises a set of training transitions. Each training transition may comprise an observation characterizing a state of the environment at a time step; an action performed by the agent at the time step; and an observation characterizing a subsequent (next) state of the environment at a subsequent (next) time step. The environment transitions from the state to the subsequent state in response to the action.

In some implementations the training data is obtained from online interactions with the environment 104, as illustrated in FIG. 1. This can involve: obtaining an observation 106 characterizing the state of the environment at a time step, processing the observation characterizing the state of the environment at the time step using the policy neural network 120 to generate an action selection output 122, selecting the action 108 to be performed by the agent at the time step using the action selection output, and obtaining an observation 106 characterizing a subsequent state of the environment at a subsequent time step, after the action has been performed by the agent. A corresponding training transition can then be stored, e.g. in a replay buffer, for later use.

The policy neural network 120 is configured to process an observation characterizing a state of the environment, in accordance with learnable parameters, e.g. weights, of the policy neural network, to generate the action selection output 122 for controlling the agent.

In general an action to be performed by the agent is selected based on the action selection output 122 of the policy neural network. The action may be continuous or discrete or a mixture of both; it may comprise multiple individual actions. As some examples, the action selection output may directly identify an action to be performed, e.g. it may output a value that defines the action, e.g. a speed or torque, or it may parameterize a distribution from which the action to be performed is sampled or selected. For example the action selection output 122 of the policy neural network may be used to obtain values of one or more parameters that characterize a distribution, such as a Gaussian distribution, from which the action to be performed may be sampled stochastically or selected deterministically, e.g. as a mean of the distribution. In some implementations an action may be selected stochastically during training and deterministically during inference, i.e. when using the trained policy neural network to select actions to perform a task.

In some implementations training the policy neural network 120 through reinforcement learning uses the state-action value neural network 130. The state-action value neural network 130 is configured to process an observation characterizing a state of the environment and an action, in accordance with learnable parameters, e.g. weights, of the state-action value neural network, to generate a state-action value 132, i.e. a Q-value Q(s, a) for observation (state) s and action a.

In general the state-action value (Q-value) for an action can be an estimate of a return, i.e. a time-discounted sum of rewards, that would result from the agent performing the action in response to the current observation and thereafter selecting future actions performed by the agent in accordance with the current action selection policy, i.e. the action selection policy defined by the current parameter values of the policy neural network 120.

The reward neural network 140 is configured to process an observation characterizing a state of the environment, and an action, in accordance with learnable parameters, e.g. weights, of the reward neural network, to generate a refined reward output 142. The reward neural network is trained as described later, using a reward objective function that depends on the rewards defined by the shaped reward, to refine the shaped reward. In some implementations training the policy neural network through reinforcement learning using the shaped reward involves training the policy neural network through reinforcement learning using the refined reward.

The policy neural network 120, the state-action value neural network 130, and the reward neural network 140, may have any suitable architecture. For example they may include one or more feed forward neural network layers, one or more recurrent neural network layers, one or more convolutional neural network layers, one or more attention neural network layers, or one or more normalization layers. In some implementations the policy neural network 120 can usefully have a particular final layer architecture, as described later. Where the observations include image observations of the environment one or more of these neural networks may share a common representation generation neural network. The representation generation neural network can be configured to process an image observation to generate a representation of the image observation that is used by downstream neural network(s). As an example the representation generation neural network may be based on a ResNet or other architecture; it may be pre-trained and not trained further whilst the other neural networks in the system are trained.

The system 100 includes a training engine 150 (not needed after training) to train the policy neural network 120, and other neural networks where present. In general training a neural network as described herein comprises backpropagating gradients of an objective function to update learnable parameters, e.g. weights, of the neural network. The learnable parameters may be updated using any appropriate gradient descent optimization algorithm, e.g. Adam or another optimization algorithm.

The policy neural network may be trained to select actions to be performed by an agent, such as a mechanical agent, in a real-world environment to perform a task. However the demonstration environment may be a simulated environment, in particular a simulation of such a real-world environment. Also or instead the policy neural network can be fine-tuned using reinforcement learning in a simulation of a real-world environment, e.g. using a simulation of an agent. Afterwards the policy neural network can be used to select actions to be performed by a real-world agent, e.g. a mechanical agent, acting in a real-world environment to perform the task. Thus in general the observations may relate to a real-world environment (even if simulated), and the actions may relate to actions to be performed by the agent acting in the real-world environment to perform the task (even if the actions are simulated). That is one or both of the environment and the demonstration environment may be a simulation, but the system may be used, during or after training, in a real-world environment.

Some example applications of the described techniques are given later. Merely as an illustrative example, the agent can be a mechanical agent such as a robot, acting in the real-world environment to perform a task. The observations may comprise observations from sensors sensing the real-world environment, e.g. image observations from one or more image sensors, e.g. video cameras, sensing the real-world environment. The actions may comprise control signals to control the robot or other mechanical agent, e.g. position, velocity, or force, torque, or acceleration data for one or more joints of a robot or parts of another mechanical agent. Using the techniques described herein the policy neural network can learn to perform the task, e.g. from human demonstrations.

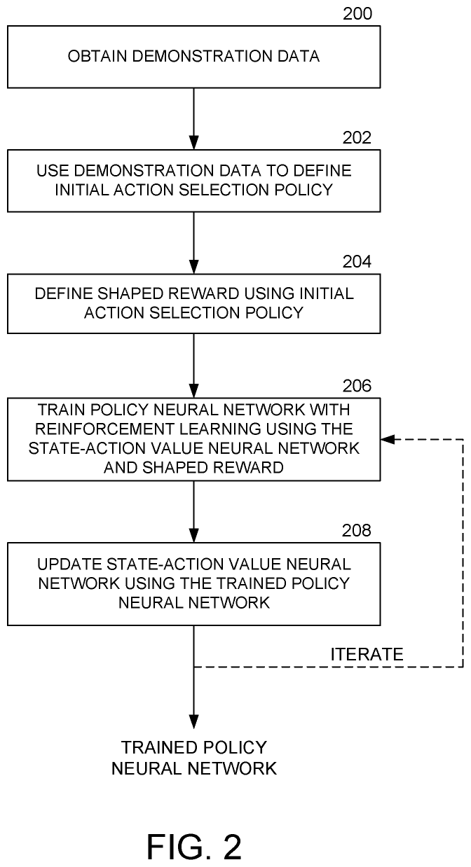

FIG. 2 is a flow diagram of an example process for training a policy neural network, for convenience described as the policy neural network 120 of FIG. 1. The process of FIG. 2 may be implemented by one or more computers in one or more locations.

At step 200 the process obtains demonstration data, e.g. from a data store. The process trains the policy neural network 120 using the demonstration data to define an initial action selection policy (step 202). The initial action selection policy is characterized by actions selected by the policy neural network in response to observations processed by the policy neural network.

At this stage the method trains the policy neural network 120 using the demonstration data such that actions selected using the action selection policy output are encouraged to match the actions of the demonstrating agent, to define the initial action selection policy q₁(a|s), for action a and observation s.

The policy neural network can be trained using a behavioral cloning technique, i.e. using a supervised learning objective based on the demonstration data, using demonstration observations and demonstration actions sampled from the demonstration data. Any behavioral cloning technique can be used. For example the supervised learning objective can be based on the log likelihood of the actions in the demonstration data, and may include a term that aims to maximize this likelihood. The supervised learning objective can, e.g., include a term that depends on the square of a difference between an action selected by the policy neural network for an observation and a corresponding action in the demonstration data for the same observation, such as a mean squared error term. Optionally the supervised learning objective may include a regularization term.

The process defines a shaped reward using the initial action selection policy, q₁(a|s) (step 204). The shaped reward can define a reward for an action, a, taken in response to an observation, s, characterizing a state of the environment, \tilde{r}(s, a).

In implementations defining the shaped reward using the initial action selection policy comprises determining a metric of a difference between the initial action selection policy, q₁(a|s), and a prior action selection policy, p(a|s), e.g. a metric of a difference between action distributions of the initial action selection policy and the prior action selection policy, e.g. a metric of a KL divergence. In implementations this involves determining a logarithmic difference between the initial action selection policy and the prior action selection policy. Optionally the shaped reward may be upper-bounded. The prior action selection policy, p(a|s), can be a uniform action selection policy, e.g. one in which there is a uniform probability of different actions (within the relevant action space).

This approach can be understood as defining a shaped reward for which, approximately, the reward is positive if the action, a, and observation, s, are in the demonstration data; the reward is negative if the observation is in the demonstration data but the action is not in the demonstration data; and the reward is zero if the observation is not in the demonstration data. In some implementations, as described later, the shaped reward (or refined reward) may be modified to encode a negative bias, to encourage the agent to adopt a “minimum time” strategy.

Behavioral cloning suffers from compounding errors, that is a small training error may cause the agent to visit a state out of the expert demonstration distribution, which in turn causes a larger decision error and a transition to further unseen states. The shaped reward can encourage actions that return to the demonstration distribution since the reward is higher in this region. Moreover the shaped reward can be shown to be coherent, i.e. consistent, with reinforcement learning, and thus reinforcement learning using the shaped reward can refine the initial action selection policy rather than unlearning the initial policy.

In some particular implementations determining the metric of the difference between q₁(a|s), and p(a|s) involves evaluating the initial action selection policy for the action taken in response to the observation characterizing a state of the environment to determine an initial action selection policy value, evaluating the prior action selection policy for the action taken in response to the observation characterizing a state of the environment to determine a prior action selection policy value, and determining a logarithm of a ratio of the initial action selection policy value and the prior action selection policy value. The metric of the difference between the initial action selection policy and the prior action selection policy may then be determined from the logarithm of the ratio, optionally scaled by an initial weight or “temperature”, α.

For example in implementations the shaped reward may be determined as

$$\tilde{r} ( s , a ) = a log \frac{{q}_{1} ( a \vert s )}{p ( a \vert s )} = a ( log {q}_{1} ( a \vert s ) - log p ( a \vert s ) )$$

The policy neural network is then trained, through reinforcement learning, using the shaped reward (step 206).

In an example implementation training the policy neural network through reinforcement learning using the shaped reward employs Q-learning, in which a critic is trained using the shaped reward, and the policy neural network is trained using the critic. The shaped reward can be used directly, or it can be used by training the reward neural network 140 to generate a refined reward.

In general training the policy neural network using reinforcement learning can refer to iteratively adjusting values of the learnable parameters of the policy neural network to encourage greater rewards for actions selected using the policy neural network, e.g. to increase a cumulative measure of rewards for actions selected using the policy neural network, such as a time-discounted sum of rewards or “return”. This may be done by training using a reinforcement learning objective function, e.g. one that determines a Bellman error. A discounted reward can be obtained by multiplying the reward by a discount factor 0<γ<1.

Training the policy neural network through reinforcement learning using the shaped reward generally involves obtaining training data 112 as described previously. The shaped reward can be used to obtain a reward for the action, a, of the agent at a time step in response to the observation, s, characterizing the state of the environment at the time step. The reward can relate to the subsequent state of the environment. In some implementations the reward comprises the shaped reward. In some implementations the reward is obtained using the shaped reward by training the reward neural network 140 using the shaped reward, and using the refined reward output 142 from the reward neural network 140 as the reward.

The policy neural network is trained using a reinforcement learning technique based on the reward by, in implementations, training the state-action value neural network 130 using the reward. That is, in some implementations, an actor-critic reinforcement learning technique is used. Such implementations can use the state-action value neural network 130 as the critic.

The state-action value neural network 130 (critic) can be used to process an observation and an action in a training transition of the training data 112 to generate a state-action value, i.e. Q-value, for the training transition. The critic can be used to obtain a version of the policy neural network with an improved action selection policy, in particular by training the policy neural network using state-action values (Q-values) generated by the state-action value neural network (critic) to update the policy neural network parameters. Some particular examples of this are given later.

The critic, i.e. the state-action value neural network 130, can be updated using the version of the policy neural network with the improved action selection policy (step 208) (and the shaped reward or refined reward). More particularly training data 112 obtained using the action selection policy of the updated policy neural network can be used to train the state-action value neural network 130. This can involve the agent 102 interacting with the environment 104 using the version of the policy neural network with the improved action selection policy, to collect and store training data 112 that is used to train the state-action value neural network 130.

In general the training may be performed iteratively, training the policy neural network using state-action values generated by the state-action value neural network to obtain a version of the policy neural network with an improved action selection policy, and training the state-action value neural network using the version of the policy neural network with the improved action selection policy.

Training with Q-values differs from training using the shaped reward directly, i.e. greedily, and facilitates deviating from the initial action selection policy. This can further reduce compounding errors, by encouraging the agent to stay within, and return to, the demonstration distribution without “unlearning” the initial policy.

Some implementations of the process initialize the state-action value neural network 130 prior to using this to train the policy neural network. However empirically this appears not to be particularly important where an iterative training process is used. The state-action value neural network 130 can be initialized by training it using the demonstration data.

In general the state-action value neural network 130 can be trained by a Q-learning technique such as SARSA (state-action-reward-state-action), e.g. based on a Bellman error. For example, the state-action value neural network can be trained using an objective function comprising a term based on a reward defined by the shaped reward for an observation, e.g. the shaped reward or the refined reward, and a corresponding action. More particularly the term may comprise a sum of a reward for the observation and corresponding action, and a discounted state-action value for a subsequent (next) observation and corresponding (next) action. The observations and actions may be obtained from the training data 112 or, if initializing the state-action value neural network 130, from the demonstration data 110. In some other implementations the next action may be one that would be selected using a current version of the policy neural network.

Optionally the reward may be combined with an external reward, e.g. in a weighted combination. The external reward can be a reward received from the environment in response to an action performed by the agent that characterizes progress made on the task, e.g. that represents completion of, or progress towards completion of, the task.

In implementations where the state-action value neural network 130 is initialized, during initialization the objective function may comprise a second term dependent upon a difference between the initial action selection policy and a (an initial) reference action selection policy, π(a|s), such as the initial action selection policy or the prior action selection policy. For example during initialization the state-action value neural network 130 can be trained using a temporal difference target given by

\tilde{r}(s,a)+γ(Q(s′,a′)−α(log q₁(a|s)−log π(a|s)))

where s, a, s′, a′ are sampled from the demonstration data (the ′ indicating the subsequent state and action to s, a), π(a|s) is p(a|s) or q₁(a|s), and 0<γ<1 is a discount factor.

In some implementations, when training the state-action value neural network 130 using the training data 112 the coherency of the Q-learning can be improved by including an auxiliary loss that aims to minimize the critic gradient with respect to the demonstration actions. More particularly the auxiliary loss can be based on a gradient of the state-action value 132 (Q-value) with respect to actions from the demonstration data, e.g. ∇ₐQ(s, a) where s and a are sampled from the demonstration data 110 (not the training data 112). For example the state-action value neural network 130 may be trained to minimize the objective:

[symbol]

_{Q}= [symbol] [(Q(s,a)−Q*(s,a))²]+ [symbol] _{s,a~D}[|∇ₐQ(s,a)|²]

where D denotes the demonstration data 110, [symbol] denotes a combination of the training data 112 and the demonstration data 110 ( [symbol] denoting an expectation or average and ~ denoting sampling), and Q*(s, a) denotes a target Q-value, e.g. \tilde{r}(s, a)+γQ(s′, a′). In practice for stability the target Q-value Q*(s, a) may be obtained using a target neural network that is a periodically updated copy, or exponential moving average, of the state-action value neural network 130.

In actor-critic implementations the policy neural network can be trained using state-action values generated by the state-action value neural network 130. In general this involves training the policy neural network on each of a plurality of training transitions in the training data 112, and optionally also in the demonstration data 110, i.e. on the observations and corresponding actions in the training data 112, and optionally also on the observations and corresponding actions in the demonstration data 110.

The training can involve processing the observation and action in a training transition using the state-action value neural network to generate a state-action value 132 for the training transition. The training can determine a training target for the policy neural network from the state-action value 132 for the training transition. This can be done for a plurality of transitions in the training data, e.g. for a minibatch of transitions. The policy neural network can then be trained using the training target(s).

In implementations the training target comprises any suitable reinforcement learning objective for training the policy neural network, e.g. one based on the state-action value 132. In implementations the objective is also dependent on a metric of a difference between the improved action selection policy and a (training) reference action selection policy, e.g. the initial action selection policy or an earlier version of the fine-tuned policy.

The metric of the difference between may be determined as a logarithmic difference between the improved action selection policy and the (training) reference action selection policy, or even the prior action selection policy. This metric can be viewed as characterizing a KL divergence between the improved action selection policy and the (training) reference action selection policy. This metric may be weighted by a weight or temperature, β, that characterizes a degree to which divergence between the improved action selection policy and the (training) reference action selection policy is penalized. In implementations β<α, where α characterizes a degree to which divergence between the initial action selection policy and the prior action selection policy is penalized.

The training target may be based on an exponential of the state-action value for the training transition, optionally weighted by a second, refinement temperature, i.e. β, which as described is, in implementations, less than the initial temperature, α. In particular the training target may be based on a product of an exponential of the state-action value for the training transition and an action score for the transition according to the (training) reference action selection policy (π(s.a)) weighted by β, e.g. according to exp(β⁻¹Q(s, a))π(s.a). In practice such a training target to improve the action selection policy can be implemented as a combination of a Q-value from the state-action value neural network 130 and of the above described metric.

For example, in one particular implementation an objective to be minimized for training the policy neural network can be determined as

[symbol]

= [symbol] [Q(s,a)−β((log qₙ(a|s)−log q₁(a|s)))]

where qₙ(a|s) is the current action selection policy at iteration n, defined by current learnable parameter values of the policy neural network, q₁(a|s) is the initial action selection policy defined by learnable parameter values of the policy neural network after training the policy neural network 120 using the demonstration data, [symbol] denotes a combination of the training data 112 and the demonstration data 110, and β is a weight or temperature parameter as described above. In implementations α and β are hyperparameters that may be determined by a hyperparameter sweep, e.g. over a range [1.0,0.01]. As another example, α can be set as

$$a = {d}_{a}^{- 1}$$

where dₐ is the action dimension.

As previously mentioned, in some implementations of the described techniques, rather than using the shaped reward directly for the reinforcement learning, a refined reward is generated using the shaped reward and the reinforcement learning uses the refined reward.

Thus in some implementations the shaped reward is refined using a reward model, i.e. the reward neural network 140. The reward neural network 140 can be trained to generate the refined reward output 142 using rewards defined by the shaped reward for observations and actions in the training data 112 (as well as in the demonstration data 110).

This can involve training the reward neural network 140 using a reward objective function that depends on the rewards defined by the shaped reward for observations and actions in the training data 112. More particularly the reward objective function can include a correction term that corrects for a difference between the current action selection policy defined by the current version of the action selection neural network and the prior action selection policy used for defining the shaped reward. This can mitigate exploitation of an earlier action selection policy during optimization.

As one example, the reward objective function can be defined as:

[symbol]

ᵣ= [symbol] _{s,a~D}[r_{θ}(s,a)]− [symbol] _{s,a~q}_{_{θ}}[r_{θ}(s,a)]

where q_{θ}(a|s) is the action selection policy of the current version of the policy neural network 120, e.g. as approximately defined by the training data 112, and r_{θ}(s, a)=α(log q_{θ}(a|s)−log p(a|s)). Note that here the parameters of the reward function can be different from the parameters of the policy neural network, and θ is then overloaded in the equation for r_{θ}(s, a). That is, more precisely r_{φ}(s, a)=α(log q_{φ}(a|s)−log p(a|s)) where φ denotes the parameters of the reward function, i.e. of the reward neural network 140. This expresses that in implementations the trainable part of the reward function, i.e. the parameters φ, can be initialized to define a copy of the initial action selection policy q₁(a|s) that was trained from the demonstration data, and that the current action selection policy q_{θ}(a|s) (i.e. the current version of the policy neural network 120) is not then used for computing the rewards. For reward refinement the parameters φ comprise the learnable parameters of the reward neural network 140, and when the reward neural network 140 is trained, it is these parameters that are updated (and not the parameters θ of the current version of the policy neural network 120, q_{θ}(a|s)).

The reward objective function refines the reward neural network 140 to give high reward to state-action pairs in the demonstration data (the first term) and low reward to state-action pairs generated by the trained policy q_{θ}(a|s) (the second term). The first term encourages the policy to stay close to the behavioral cloning policy. In practice the second term can suffer from bias and a better version of the second term is [symbol] _{s,a~q}_{_{θ}}[r_{θ}(s, a)−1+exp(−r_{θ}(s, a))]. In practice samples can be taken from the training data 112 and from the demonstration data 110 to evaluate the objective.

Optionally the shaped reward or the refined reward can be upper bounded. Merely as an example, where

$$a = {d}_{a}^{- 1}$$

an upper bound may be defined as

$$r ( s , a ) \leq \frac{1}{{d}_{a}} ( - 0.5 {d}_{a} log 2 π {σ}_{min}^{2} + c + {d}_{a} log 2 ) ,$$

where

$${σ}_{min}^{2}$$

and c are bias terms.

As described above the shaped (or refined) reward is positive. A negatively biased shaped (or refined) reward can be obtained by determining an upper bound and subtracting it from the shaped (or refined) reward. For some tasks, e.g. robot manipulation tasks, it has been found that positively biased rewards encourage survival, and negatively biased rewards encourage minimum time strategies (which can be more desirable).

In implementations, once the policy neural network 120 has been trained to define the initial action selection policy, the action selection policy may be iteratively optimized by using the policy neural network 120 to interact with the environment.

This can involve, at each of a plurality of time steps, t, selecting an action for the agent to perform in a state of the environment, sₜ, e.g. according to aₜ~q_{θ}_{ₜ} (·|sₜ), the agent performing the action to transition to a subsequent state of the environment, sₜ₊₁. The training data transitions (sₜ, aₜ, sₜ₊₁) can be stored, e.g. in a replay buffer as previously described. The state-action value neural network 130 can then be updated, i.e. trained, as previously described, using a minibatch of the training data. Optionally the reward neural network 140 can also be updated, i.e. trained, as described above. The policy neural network 120 can then be trained using the updated state-action value neural network 130, using either the shaped reward or the updated refined reward. This iterative process may then be repeated.

In some implementations the policy neural network comprises a final layer with a periodic activation function (ƒₚₑᵣ). For example the periodic activation function may be configured so that for a shift r in an input x, ƒₚₑᵣ(x)=ƒₚₑᵣ(x+r). Some examples of a periodic activation function that can be used include a sinusoidal activation, a triangle wave activation, and a periodic ReLU activation. Using a periodic activation function can help to define the action selection policy outside a distribution of the demonstration data. For example it can assist recovery of the agent if the system trains the action selection policy so that it reverts to a uniform prior (random actions) outside this distribution.

An output of the final layer can be combined with a set of probability distributions, to obtain a representation of the action selection policy as a probability distribution from which an action can be sampled. The probability distributions may be Gaussian, e.g. to model the action selection policy as a Gaussian Process, or some other distribution such as a Student-t or Cauchy distribution.

As a particular example, generating the action selection output may comprise processing a feature vector input, φ′(s), to the final layer from a preceding layer of the policy neural network by determining a first set of weights, \tilde{W}. In some implementations these weights are learned parameters of the policy neural network 120; in some implementations they can be drawn from the same set of probability distributions used to represent the action selection policy. In implementations the feature vector input can have a relatively small number of dimensions, e.g. <20, to compress the internal representation.

Each element of the feature vector input is weighted by a respective one of the first set of weights to determine an activation function input, and the activation function input is processed using the periodic activation function to determine a final layer output, φ(s)=ƒₚₑᵣ(\tilde{W}φ′(s), a modified feature vector. The action selection output can then be generated from the final layer output, φ(s).

As an example, the action selection output may be generated from the final layer output by combining the modified feature vector, φ(s), with the set of probability distributions, which may also be referred to as weights. That is, the action selection output may be described as being generated by weighted combination of each element of the modified feature vector, φ(s). For example if Gaussian distributions are used as (a second set of) weights, with wᵢ= [symbol] (μᵢ, Σᵢ) and W=[w₁, . . . wᵢ, . . . , w_{d}_{ₐ}]^{T}, the action selection output may be defined by z(s)=Wφ(s).

Depending on the set of probability distributions used, e.g. if Gaussian distributions are used, z(s) may have infinite support, i.e. the action selection output may be unbounded. Optionally the action selection output may then be defined as a nonlinear function of z(s), such as tanh(·). For example with a=tanh z(s), aᵢ is in the range [−1,1] and has a probability density given by:

$$q ( {a}_{i} \vert s ) = 𝒩 ( {z}_{i} ; {μ}_{i}^{T} {ϕ ( s )}^{T} {\sum }_{i} ϕ ( s ) ) \cdot {\vert det ( \frac{{da}_{i}}{{dZ}_{i}} ) \vert}^{- 1}$$

where if log q(aᵢ|s) is evaluated the second term can be determined as

$$- {\sum }_{i = 1}^{n} log ( 1 - tan {h}^{2} {z}_{i} )$$

where n is the dimension of z.

When the policy neural network 120 has this architecture, optionally training the policy neural network 120 initially using the demonstration data to define the initial action selection policy can use a modified objective for increased accuracy. In particular the objective, i.e. loss, may be defined as:

[symbol]

= [symbol] _{s,a~D}[(a−μ(s))²−log \tilde{q}(a|s)]

\tilde{q}(a|s)= [symbol] (sg(μ(s),Σ(s)

where sg(·) denotes a stop gradient and where, if the policy neural network has separate outputs for mean μ(s) and variance Σ(s), the torso features are only trained using the mean squared error part of the objective.

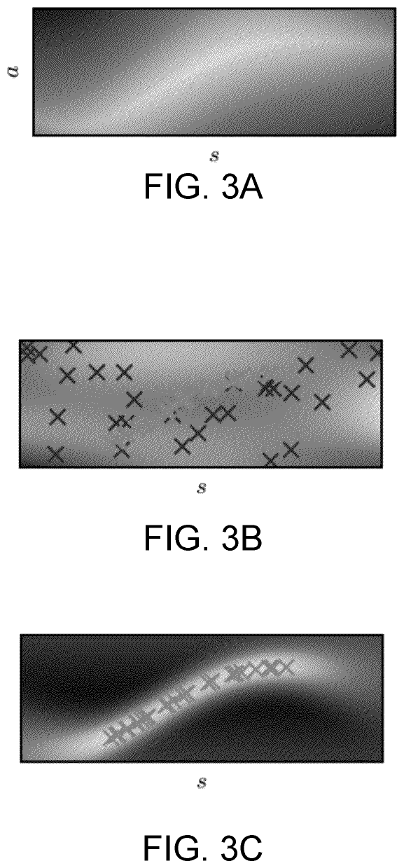

FIG. 3 illustrates reward shaping for a toy example: FIG. 3a shows a state-action (s, a) reward for a toy task. FIG. 3B illustrates that inverse reinforcement learning with a classifier-based approach, such as GAIL (Generative Adversarial Imitation Learning), can struggle to resolve the difference between expert (dark crosses) and non-expert (light crosses) samples. FIG. 3C shows that a shaped reward determined as described herein can accurately match a true reward.

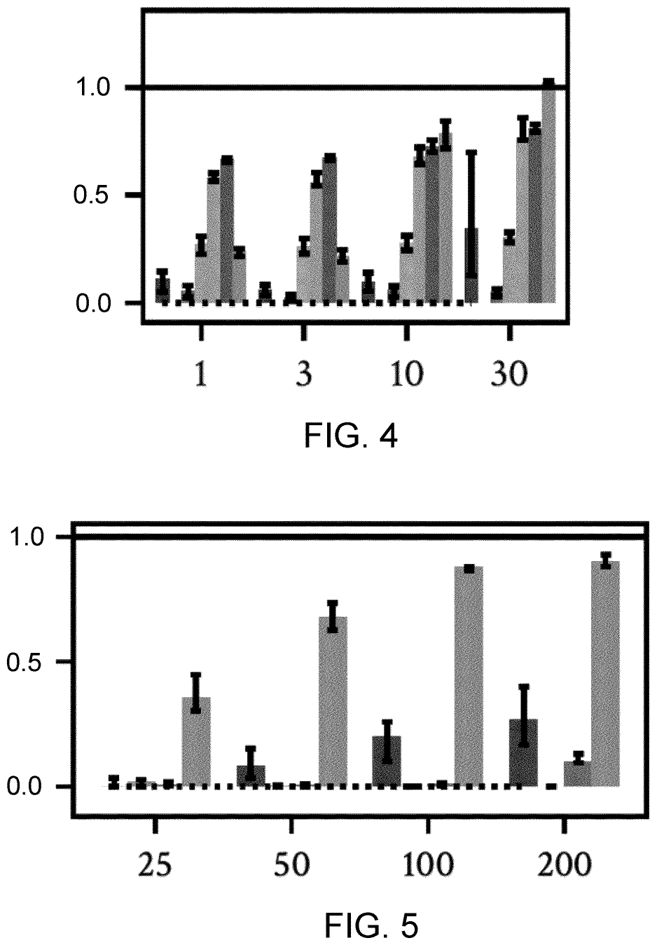

FIG. 4 illustrates the comparative performance of various different techniques when learning from demonstrations with, respectively, 1, 3, 10 and 30 demonstrations on the x-axis and return on the y-axis, for the HalfCheetah-v2 task of Gym (Brockman et al. arXiv:1606.01540 2016). The demonstration data is from the open source D4RL dataset as described in Fu et al., arXiv:2004.07219, 2020. FIG. 4 relates to offline learning, i.e. where the training data 112 comprises a static, supplementary dataset, which is a challenging setting. In order from left to right, the bars for each respective number of demonstrations represent, respectively, behavioral cloning (BC), IQ-learn (Garg et al., “IQ-learn: Inverse soft-Q learning for imitation”, Advances in Neural Information Processing Systems, 2021), PPIL (Viano et al., “Proximal Point Imitation Learning”, Advances in Neural Information Processing Systems, 2022), DemoDICE (Kim et al., “Offline imitation learning with supplementary imperfect demonstrations”, International Conference on Learning Representations, 2022), SMODICE (Ma et al. “Versatile offline imitation from observations and examples via regularized state-occupancy matching”, International Conference on Machine Learning, 2022), and an implementation of the techniques described herein. It can be seen that in this particular setting all the approaches perform poorly with smaller numbers of demonstrations, but that for 30 demonstrations the described technique (the far right bar) outperforms other approaches.

FIG. 5 illustrates the comparative performance of various different techniques when learning from demonstrations with, respectively, 25, 50, 100, and 200 demonstrations on the x-axis and a success measure on the y-axis. FIG. 5 relates to a difficult insertion task (Nut AssemblySquare) that involves mixed quality human demonstrations from the open “robomimic” datasets (Mandlekar et al., “What matters in learning from offline human demonstrations for robot manipulation”, Conference on Robot Learning, 2021), followed by online interaction with the environment. In order from left to right, the bars for each respective number of demonstrations represent, respectively, BC, DAC (Kostrikov et al., “Discriminator-actor-critic: Addressing sample inefficiency and reward bias in adversarial imitation learning”, International Conference on Learning Representations, 2019), IQ-learn, and an implementation of the techniques described herein. FIG. 5 shows that implementations of the described techniques can succeed where other approaches struggle.

### Example Applications

The techniques described herein are widely applicable and are not limited to one specific implementation. However, for illustrative purposes, some example implementations are described below.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment. As another example, the agent can be a car, boat, or aircraft. The described techniques enable the policy neural network, for example, to learn to control the robot to perform the task, or to learn to drive the car, boat, or aircraft.

The observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

The actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

As previously described, the environment may be a simulation of a particular real-world environment, and the agent may be implemented as one or more computers interacting with the simulated environment. For example, the simulated environment may be a simulation of a robot or vehicle and the system may be trained on the simulation and then, once trained, used in the particular or a similar real-world environment for controlling a real-world mechanical agent. This can avoid unnecessary wear and tear on and damage to the real-world environment or real-world agent and can allow the control neural network to be trained and evaluated on situations that occur rarely or are difficult to re-create in the real-world environment. In some cases the system may be partly trained using a simulation as described above then further trained in the real-world environment.

In some applications the real-world environment is a manufacturing environment for manufacturing a product, such as a chemical, biological, or mechanical product, or a food product (which, as used herein, includes manufacture of a food product by a kitchen robot). Then the mechanical agent can be a machine such as a robot, that operates to manufacture the product or a part thereof, or a machine that controls movement of an intermediate version or component of a product between manufacturing units. The task can be, e.g., any type of task relating to the manufacture of a product or an intermediate version or component thereof, including a control task, e.g. to minimize, use of a resource such as a task to control electrical power consumption, or water consumption, or the consumption of any material or consumable used in the manufacturing process, or to optimize a quality of the product. Such environments can include chemical synthesis, e.g. protein or drug synthesis environments where the product is a chemical, e.g. a protein or drug, or an intermediate or component thereof.

More generally the agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some applications the real-world environment is a facility in which electrical power or water is generated or used, the mechanical agent comprises a machine, and the task is to control the generation or use of electricity or water. For example the mechanical agent can be a machine that controls the delivery of electrical power or the configuration of one or more renewable power generating elements e.g. the configuration of a wind turbine or solar panels or mirrors, or the configuration of a rotating electrical power generation machine.

More generally in some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment such as a heater, a cooler, a humidifier, or other hardware that modifies a property of air in the real-world environment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

The actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

Observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

Observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that indirectly performs or controls the protein folding actions, or chemical synthesis steps, e.g. by controlling synthesis steps selected by the system automatically without human interaction. The observations may comprise direct or indirect observations of a state of the protein or chemical/intermediates/precursors and/or may be derived from simulation. Thus the system may be used to automatically synthesize a protein with a particular function such as having a binding site shape, e.g. a ligand that binds with sufficient affinity for a biological effect that it can be used as a drug. For example e.g. it may be an agonist or antagonist of a receptor or enzyme; or it may be an antibody configured to bind to an antibody target such as a virus coat protein, or a protein expressed on a cancer cell, e.g. to act as an agonist for a particular receptor or to prevent binding of another ligand and hence prevent activation of a relevant biological pathway.

In a similar way the environment may be a drug design environment such that each state is a respective state of a potential pharmaceutically active compound pharmaceutically active compound and the agent is a computer system for determining elements of the pharmaceutically active compound and/or a synthetic pathway for the pharmaceutically active compound, or a mechanical agent that performs or controls synthesis of the pharmaceutically active compound.

In some applications the agent may be a software agent i.e. a computer program, configured to perform a task. For example the environment may be a circuit or an integrated circuit design or routing environment and the agent may be configured to perform a design or routing task for routing interconnection lines of a circuit or of an integrated circuit e.g. an ASIC. Where present one or more external reward(s) may then be dependent on one or more routing metrics such as interconnect length, resistance, capacitance, impedance, loss, speed or propagation delay; and/or physical line parameters such as width, thickness or geometry, and design rules. The observations may be e.g. observations of component positions and interconnections; the actions may comprise component placing actions e.g. to define a component position or orientation and/or interconnect routing actions e.g. interconnect selection and/or placement actions. The task may be, e.g., to optimize circuit operation to reduce electrical losses, local or external interference, or heat generation, or to increase operating speed, or to minimize or optimize usage of available circuit area. The method may include making the circuit or integrated circuit to the design, or with interconnection lines routed as determined by the method.

In some applications the agent is a software agent and the environment is a real-world computing environment. In one example the agent manages distribution of tasks across computing resources e.g. on a mobile device and/or in a data center. In these applications, the observations may include observations of computing resources such as compute and/or memory capacity, or Internet-accessible resources; and the actions may include assigning tasks to particular computing resources.

In another example the software agent manages the processing, e.g. by one or more real-world servers, of a queue of continuously arriving jobs. The observations may comprise observations of the times of departures of successive jobs, or the time intervals between the departures of successive jobs, or the time a server takes to process each job, e.g. the start and end of a range of times, or the arrival times, or time intervals between the arrivals, of successive jobs, or data characterizing the type of job(s). The actions may comprise actions that allocate particular jobs to particular computing resources.

As another example the environment may comprise a real-world computer system or network, the observations may comprise any observations characterizing operation of the computer system or network, the actions performed by the software agent may comprise actions to control the operation e.g. to limit or correct abnormal or undesired operation e.g. because of the presence of a virus or other security breach.

In some applications, the environment is a real-world computing environment and the software agent manages distribution of tasks/jobs across computing resources e.g. on a mobile device and/or in a data center. In these implementations, the observations may comprise observations that relate to the operation of the computing resources in processing the tasks/jobs, the actions may include assigning tasks/jobs to particular computing resources.

In some applications the environment is a data packet communications network environment, and the agent is part of a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability.

In some applications the environment is an Internet or mobile communications environment and the agent is a software agent which manages a personalized recommendation for a user. The observations may comprise previous actions taken by the user, e.g. features characterizing these; the actions may include actions recommending items such as content items to a user. As a further example, the actions may include presenting advertisements, the observations may include advertisement impressions or a click-through count or rate, and where present an external reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The design process may include outputting the design for manufacture, e.g. in the form of computer executable instructions for manufacturing the entity. The process may include making the entity according to the design. Thus the design of an entity may be optimized, e.g. by reinforcement learning, and then the optimized design output for manufacturing the entity, e.g. as computer executable instructions; an entity with the optimized design may then be manufactured.

In the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. The agent may be implemented as one or more computers interacting with the simulated environment. The simulated environment may be a simulation of a particular real-world environment and agent and the system may be used to select actions in the simulated environment during training and may then be deployed for controlling a real-world agent in the particular real-world environment that was the subject of the simulation.

In some implementations the observations are observations of a real-world environment in which a human is performing a task, e.g. an image observation from an image sensor and/or a language observation from a speech recognition system; and the actions are language actions that instruct the human in performing the task using natural language. A language action may be an action that outputs a natural language sentence, e.g. by defining a sequence of language tokens, e.g. words or wordpieces, to be emitted at sequential time steps.

The agent may comprise a user interface device such as a digital assistant, e.g. a smart speaker or smart display or other device, e.g. with a natural language input and/or output. The user interface device may comprise, e.g., a mobile device, a keyboard (and optionally display), or a speech-based input mechanism, e.g. to input audio data characterizing a speech waveform of speech representing the input from the user in the natural or computer language and to convert the audio data into tokens representing the speech in the natural or computer language, i.e. representing a transcription of the spoken input. The user interface can also include a text or speech-based output, e.g. a display and/or a text-to-speech subsystem. The system can learn to copy a demonstration agent, such as a human giving instructions in how to perform a task, e.g. to another human, and can learn to teach the task, e.g. skill, to a human.

Optionally, in any of the above implementations, the observation at any given time step may include data from a previous time step that may be beneficial in characterizing the environment, e.g., the action performed at the previous time step.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method of training a policy neural network to select actions to be performed by an agent in an environment to perform a task, wherein the policy neural network is configured to process an observation characterizing a state of the environment to generate an action selection output for controlling the agent, the method comprising:
obtaining demonstration data comprising a sequence of demonstration observations and demonstration actions of a demonstrating agent performing the task, wherein the demonstration observations characterize states of a demonstration environment in which the demonstrating agent performs the task and the demonstration actions comprise actions the demonstrating agent takes to perform the task;
training the policy neural network using the demonstration data to define an initial action selection policy, wherein the initial action selection policy is characterized by actions selected by the policy neural network in response to observations processed by the policy neural network;
defining a shaped reward using the initial action selection policy, wherein the shaped reward defines a reward for an action taken in response to an observation characterizing a state of the environment; and
training the policy neural network through reinforcement learning using the shaped reward.

2. The method of claim 1, wherein training the policy neural network through reinforcement learning using the shaped reward comprises:
obtaining training data comprising a set of training transitions, each training transition comprising:
an observation characterizing a state of the environment at a time step;
an action performed by the agent at the time step; and
an observation characterizing a subsequent state of the environment at a subsequent time step, where the environment transitions from the state to the subsequent state in response to the action;
using the shaped reward to obtain a reward for the action of the agent at the time step in response to the observation characterizing the state of the environment at the time step, wherein the reward relates to the subsequent state of the environment; and
training the policy neural network using a reinforcement learning technique based on the reward.

3. The method of claim 2, wherein obtaining the training data comprising the set of training transitions comprises:
obtaining the observation characterizing the state of the environment at the time step;
processing the observation characterizing the state of the environment at the time step using the policy neural network to generate the action selection output;
selecting the action to be performed by the agent at the time step; and
obtaining the observation characterizing the subsequent state of the environment at the subsequent time step.

4. The method of claim 1, wherein defining the shaped reward using the initial action selection policy comprises:
determining a metric of a difference between the initial action selection policy and a prior action selection policy.

5. The method of claim 4, wherein determining the metric of the difference between the initial action selection policy and the prior action selection policy comprises determining a logarithmic difference between the initial action selection policy and the prior action selection policy.

6. The method of claim 4, wherein determining the metric of the difference between the initial action selection policy and the prior action selection policy comprises:
evaluating the initial action selection policy for the action taken in response to the observation characterizing a state of the environment to determine an initial action selection policy value;
evaluating the prior action selection policy for the action taken in response to the observation characterizing a state of the environment to determine a prior action selection policy value;
determining a logarithm of a ratio of the initial action selection policy value and the prior action selection policy value; and
determining the metric of the difference between the initial action selection policy and the prior action selection policy from the logarithm of the ratio.

7. The method of claim 4, wherein the prior action selection policy comprises a uniform action selection policy.

8. The method of claim 1, further comprising:
training the policy neural network using state-action values generated by a state-action value neural network to obtain a version of the policy neural network with an improved action selection policy, wherein the state-action value neural network is configured to process an observation characterizing a state of the environment and an action to generate a state-action value.

9. The method of claim 1, further comprising:
initializing the state-action value neural network by training the state-action value neural network using the demonstration data.

10. The method of claim 9, wherein training the state-action value neural network using the demonstration data comprises training the state-action value neural network using an objective function comprising a first term based on the reward defined by the shaped reward for a demonstration observation and a corresponding demonstration action, and a second term dependent upon a difference between the initial action selection policy and a reference action selection policy.

11. The method of claim 8, wherein training the policy neural network using state-action values generated by the state-action value neural network comprises:
for each of a plurality of training transitions in the training data:
processing the observation and action in the training transition using the state-action value neural network to generate a state-action value for the training transition, and
determining a training target for the policy neural network from the state-action value for the training transition; and
training the policy neural network using the training targets.

12. The method of claim 11, wherein the training target for the policy neural network from the state-action value for the training transition is based on an exponential of the state-action value for the training transition, in particular on a product of an exponential of the state-action value for the training transition and an action score according to a reference action selection policy.

13. The method of claim 8, further comprising:
training the state-action value neural network using the version of the policy neural network with the improved action selection policy.

14. The method of claim 13, comprising iteratively: training the policy neural network using state-action values generated by the state-action value neural network to obtain a version of the policy neural network with an improved action selection policy, and training the state-action value neural network using the version of the policy neural network with the improved action selection policy.

15. The method of claim 1, wherein training the policy neural network comprises:
training the policy neural network using an objective function dependent on a metric of a difference between the improved action selection policy and a reference action selection policy.

16. The method of claim 15, comprising determining the metric of the difference between the improved action selection policy and the reference action selection policy as a logarithmic difference between the improved action selection policy and the reference action selection policy.

17. The method of claim 1, wherein the policy neural network comprises a final layer with a periodic activation function.

18. The method of claim 17, comprising generating the action selection output for controlling the agent by:
processing a feature vector input to the final layer from a preceding layer of the policy neural network by:
determining a first set of weights,
weighting each element of the feature vector input by a respective one of the first set of weights to determine an activation function input,
processing the activation function input using a periodic activation function to determine a final layer output; and
generating the action selection output from the final layer output.

19.-25. (canceled)

26. One or more non-transitory computer storage media storing instructions that when executed by one or more computers cause the one or more computers to perform operations for training a policy neural network to select actions to be performed by an agent in an environment to perform a task, wherein the policy neural network is configured to process an observation characterizing a state of the environment to generate an action selection output for controlling the agent, the operations comprising:
obtaining demonstration data comprising a sequence of demonstration observations and demonstration actions of a demonstrating agent performing the task, wherein the demonstration observations characterize states of a demonstration environment in which the demonstrating agent performs the task and the demonstration actions comprise actions the demonstrating agent takes to perform the task;
training the policy neural network using the demonstration data to define an initial action selection policy, wherein the initial action selection policy is characterized by actions selected by the policy neural network in response to observations processed by the policy neural network;
defining a shaped reward using the initial action selection policy, wherein the shaped reward defines a reward for an action taken in response to an observation characterizing a state of the environment; and
training the policy neural network through reinforcement learning using the shaped reward.

27. A system comprising one or more computers and one or more storage devices communicatively coupled to the one or more computers, wherein the one or more storage devices store instructions that, when executed by the one or more computers, cause the one or more computers to perform operations for training a policy neural network to select actions to be performed by an agent in an environment to perform a task, wherein the policy neural network is configured to process an observation characterizing a state of the environment to generate an action selection output for controlling the agent, the operations comprising:
obtaining demonstration data comprising a sequence of demonstration observations and demonstration actions of a demonstrating agent performing the task, wherein the demonstration observations characterize states of a demonstration environment in which the demonstrating agent performs the task and the demonstration actions comprise actions the demonstrating agent takes to perform the task;
training the policy neural network using the demonstration data to define an initial action selection policy, wherein the initial action selection policy is characterized by actions selected by the policy neural network in response to observations processed by the policy neural network;
defining a shaped reward using the initial action selection policy, wherein the shaped reward defines a reward for an action taken in response to an observation characterizing a state of the environment; and
training the policy neural network through reinforcement learning using the shaped reward.
